(19) United States
(12) Patent Application Publication
(10) Pub. No.: US 2021/0089242 A1
(43) Pub. Date: Mar. 25, 2021

(54) IMAGE FORMING APPARATUS AND NOTIFICATION METHOD

(71) Applicant: TOSHIBA TEC KABUSHIKI KAISHA, Tokyo (JP)

(72) Inventor: Takashi UEDA, Sunto Shizuoka (JP)

(73) Assignee: TOSHIBA TEC KABUSHIKI KAISHA, Tokyo (JP)

(21) Appl. No.: 16/577,256

(22) Filed: Sep. 20, 2019

(51) Int. Cl. G06F 3/12; H04L 29/08; H04L 12/24

(52) U.S. Cl. CPC G06F 3/123; H04L 67/24; G06F 3/128; H04L 41/0213; G06F 3/1204

(57) ABSTRACT

According to one embodiment, an image forming apparatus includes a communication unit and a control unit. The communication unit performs communication with a plurality of user terminals connected to a communication network. The control unit detects the user terminal in operation based on the communication, analyzes an operating status of the user terminal based on a result of detection, and outputs a notification about availability of an own apparatus based on the analyzed operation status.

### FIELD

Embodiments described herein relate generally to an image forming apparatus and a notification method.

### BACKGROUND

Generally, an image forming apparatus such as a multifunctional peripheral (MFP) or the like operates under control of firmware. The firmware is configured for performing basic control of a computer product, an electronic device, and the like. The firmware may be updated, for example, for function improvement, performance improvement, defect correction, failure handling, and the like. The firmware is updated by replacing firmware that was used until then with new firmware. In general, the new firmware is distributed from a distribution server that distributes firmware to the image forming apparatus through a communication network, such as the Internet, an intranet, or the like.

When the firmware is updated, an administrator of the image forming apparatus (hereinafter, simply referred to as an “administrator”), for example, performs schedule setting on the date and time of performing the update by using an information processing apparatus such as an administrator terminal or the like. Accordingly, the new firmware is distributed from the distribution server to the image forming apparatus at the scheduled date and time, thereby updating the firmware controlling the image forming apparatus.

Generally, while the firmware is updated, the image forming apparatus is unable to be used. Thus, in the related arts, the administrator performed schedule setting for updating the firmware by specifying a time during which it is generally assumed that the number of users who use the image forming apparatus is small. However, the specified time is not necessarily a time during which the number of users is actually small. Accordingly, there are cases where the firmware is updated at a time during which the number of users is actually not small. In this case, convenience of the greater number of users may be reduced.

### DESCRIPTION OF THE DRAWINGS

FIG. 1 is an exterior view illustrating an overall configuration example of an image forming apparatus according to an embodiment;

FIG. 2 is a diagram illustrating a configuration example of a communication system performing updating of firmware of the image forming apparatus;

FIG. 3 is a block diagram illustrating a hardware configuration example of the image forming apparatus;

FIG. 4 is a diagram illustrating an example of identification information obtainable via a terminal detection process by the image forming apparatus;

FIG. 5 is a diagram illustrating an example of the identification information obtainable via the terminal detection process;

FIG. 6 is a diagram illustrating an example of detection result information generated by the image forming apparatus;

FIG. 7 is a diagram illustrating an example of operation rate information generated by the image forming apparatus;

FIG. 8 is a diagram illustrating an example of a time selection screen displayed by an administrator terminal according to the embodiment;

FIG. 9 is a diagram illustrating an example of an alert screen displayed by a user terminal according to the embodiment;

FIG. 10 is a flowchart of the terminal detection process by the image forming apparatus; and

FIG. 11 is a flowchart of an update process of firmware by the image forming apparatus.

### DETAILED DESCRIPTION

Embodiments provide an image forming apparatus capable of preventing decrease of convenience, and a notification method.

In general, according to one embodiment, an image forming apparatus includes a communication device and a controller. The communication device is configured to perform communications with a plurality of user terminals connected over a communication network. The controller is configured to detect which of the user terminals is in operation based on the communications, analyzes an operating status of the user terminals based on the detection, and output a notification about an availability of an image forming apparatus based on the analyzed operation status.

Hereinafter, an image forming apparatus and a notification method according to embodiments will be described with reference to drawings.

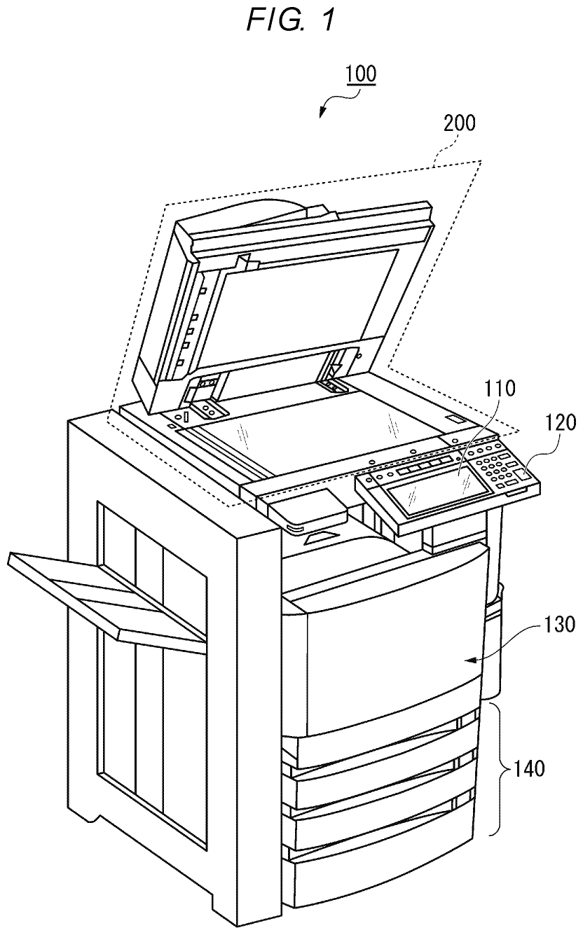

FIG. 1 is an exterior view illustrating an overall configuration example of an image forming apparatus 100 according to an embodiment. The image forming apparatus 100 is, for example, a multifunction peripheral (MFP). The image forming apparatus 100 includes a display 110, a control panel 120, a printer 130, a sheet accommodating unit 140, and an image reading unit 200.

The image forming apparatus 100 forms an image on a sheet by using a developer, such as toner. The sheet is, for example, a piece of paper or a label. The sheet is not limited as long as the image forming apparatus 100 forms an image on a surface thereof.

The display 110 is an image display apparatus, such as a liquid crystal display, an organic electro luminescence (EL) display, or the like. The display 110 displays various types of information regarding the image forming apparatus 100. The various types of information may be, for example, information indicating the number of sheets on which an image is formed.

The control panel 120 includes a plurality of buttons. The control panel 120 receives an operation of a user. The control panel 120 outputs a signal corresponding to the operation performed by the user to a controller of the image forming apparatus 100. The display 110 and the control panel 120 may be configured as an integrated touch panel.

The printer 130 forms an image on a sheet, based on image information generated by the image reading unit 200. The printer 130 may form an image on a sheet, based on image information (online data) received through a communication path. A sheet on which an image is formed may be a sheet accommodated in the sheet accommodating unit 140 or a sheet manually inserted into the image forming apparatus 100.

The sheet accommodating unit 140 accommodates a sheet used by the printer 130 to form an image. The image reading unit 200 (scanner) reads image information to be read via light and shade of a light. The image reading unit 200 outputs the read image information to the printer 130. An image corresponding to the recorded image information is imaged on a sheet by the printer 130. The image reading unit 200 may output the read image information to another information processing apparatus through a network.

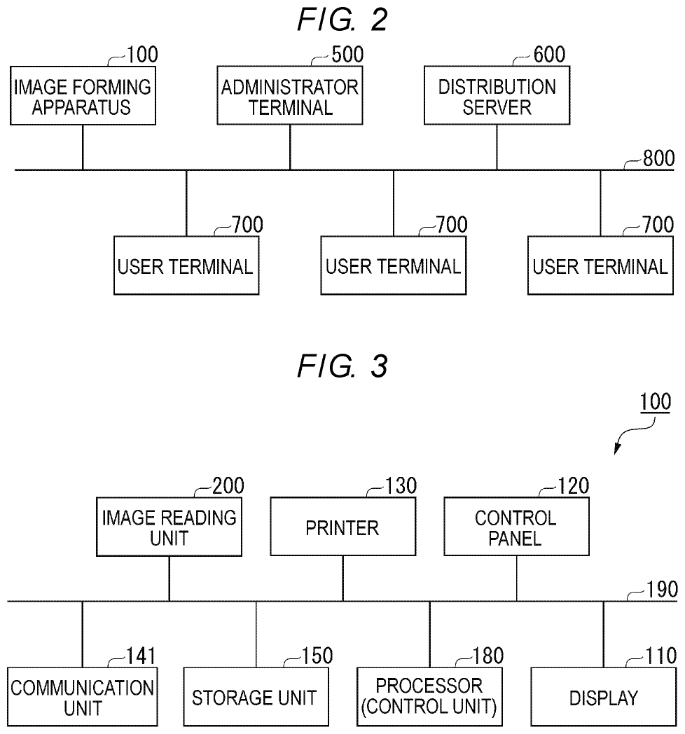

FIG. 2 is a diagram illustrating a configuration example of a communication system performing updating of firmware of the image forming apparatus 100. As illustrated in FIG. 2, the image forming apparatus 100, an administrator terminal 500, a distribution server 600, and a plurality of user terminals 700 are connected to a communication network 800.

The administrator terminal 500 is a terminal for managing the image forming apparatus 100. The administrator terminal 500 is, for example, an information processing apparatus such as a personal computer or the like. The administrator terminal 500 is used by, for example, an administrator or the like.

The distribution server 600 is a server apparatus that distributes firmware. The distribution server 600 is, for example, an information processing apparatus such as a general purpose computer. The distribution server 600 may be, for example, a server apparatus managed by an administrator or the like of the image forming apparatus 100, or a server apparatus managed by a business operator or the like providing firmware.

The user terminal 700 is a terminal for using the image forming apparatus 100. The user terminal 700 is, for example, an information processing apparatus such as a personal computer. The user terminal 700 is, for example, used by a user or the like.

The communication network 800 is, for example, a communication network constituting an intranet. The communication network 800 may be configured by including the Internet. For example, the distribution server 600 may be connected to the Internet, and the image forming apparatus 100, the administrator terminal 500, and the user terminal 700 may be connected to an intranet connected to the Internet. The communication network 800 may be a wired communication network or a wireless communication network.

FIG. 2 illustrates, as an example, a configuration in which one image forming apparatus 100, one administrator terminal 500, and one distribution server 600 are connected to the communication network 800, and three user terminals 700 are connected to the communication network 800, but the configuration is not limited thereto. A plurality of at least one of the image forming apparatus 100, the administrator terminal 500, and the distribution server 600 maybe connected to the communication network 800. Four or more user terminals 700 may be connected to the communication network 800.

When the plurality of image forming apparatuses 100 are connected to the communication network 800, the image forming apparatuses 100 usable from each user terminal 700 may each be limited. When the plurality of administrator terminals 500 are connected to the communication network 800, the image forming apparatuses 100 manageable by each administrator terminal 500 may each be limited. When the plurality of distribution servers 600 are connected to the communication network 800, the user terminals 700 to which each distribution server 600 distributes firmware may each be limited.

FIG. 3 is a block diagram illustrating a hardware configuration example of the image forming apparatus 100. The image forming apparatus 100 includes a communication unit (or communication device) 141, a storage unit 150, a processor (or controller) 180, and a bus 190. The bus 190 transmits data between each component of the image forming apparatus 100.

The communication unit 141 is a communication interface for communication connection to the communication network 800. The communication unit 141 receives new firmware transmitted from the distribution server 600. The communication unit 141 updates firmware stored in the storage unit 150 with the received new firmware, for example, under control of the processor 180.

The storage unit 150 includes a non-volatile storage medium (non-transitory storage medium), such as a flash memory, hard disk drive (HDD), or the like. The storage unit 150 stores various programs executed by the processor 180. The storage unit 150 stores, for example, firmware. The storage unit 150 stores various types of data used in the image forming apparatus 100. The storage unit 150 may further include a volatile storage medium (transitory storage medium), such as a random access memory (RAM) or the like.

The processor 180 (control unit) is a processor such as a central processing unit (CPU) or the like. The processor 180 controls operations of each component of the image forming apparatus 100. The processor 180 performs various programs stored in the storage unit 150. For example, the processor 180 executes firmware stored in the storage unit 150. For example, the processor 180 updates firmware stored in the storage unit 150 with new firmware received by the communication unit 141.

Hereinafter, an example of an update process of firmware by the image forming apparatus 100 will be described.

The image forming apparatus 100 has a detection function of detecting a terminal (for example, the user terminal 700) connected to the communication network 800 and a terminal in a state capable of using the own image forming apparatus 100. Hereinafter, the state capable of using the image forming apparatus 100 is referred to as “in operation”.

A state not in operation is, for example, a state in which power of the user terminal 700 is turned off, a state in which a communication function of the user terminal 700 is disabled, a state in which the user terminal 700 is logged off, and a state in which the user terminal 700 is in sleep (inactive).

A general detection function (a monitoring function, a scan function) mounted on a related image forming apparatus may be used as the detection function of the terminal by the image forming apparatus 100. For example, a simple network management protocol (SNMP) or the like may be used as a communication protocol realizing the detection function.

The image forming apparatus 100 performs a process of detecting the user terminal 700 in operation (hereinafter, referred to as a “terminal detection process”) during predetermined period and at predetermined intervals, according to an instruction from the administrator terminal 500.

For example, an administrator uses the administrator terminal 500 to perform an operation input for specifying a performing period and performing intervals of the terminal detection process. The administrator terminal 500 transmits input information (hereinafter, referred to as “detection setting information”) to the image forming apparatus 100 through the communication network 800.

The image forming apparatus 100 obtains the detection setting information transmitted from the administrator terminal 500. The image forming apparatus 100 performs the terminal detection process during a performing period and at performing intervals based on the obtained detection setting information. Here, for example, the image forming apparatus 100 performs the terminal detection process every hour from 8:00 to 22:00, according to the detection setting information.

The terminal detection process may be performed at even shorter intervals (for example, every 10 minutes). A performance end timing of the terminal detection process may not be pre-set and the image forming apparatus 100 may continue to perform the terminal detection process until the administrator terminal 500 obtains an end instruction.

The terminal detection process is, for example, performed as follows. The image forming apparatus 100 broadcasts instruction information to each user terminal 700 connected to the communication network 800. The instruction information stated here is, for example, instruction information for causing the user terminal 700 in operation to transmit identification information for identifying the user terminal 700 to the image forming apparatus 100.

The image forming apparatus 100 obtains the identification information transmitted from the user terminal 700 according to the instruction information. The image forming apparatus 100 stores the obtained identification information in the storage unit 150.

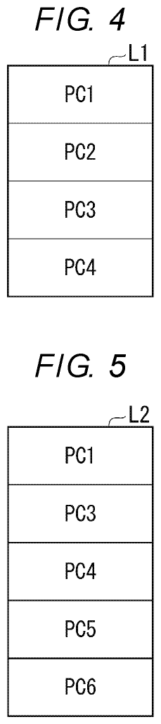

FIGS. 4 and 5 are diagrams illustrating examples of the identification information obtainable via the terminal detection process by the image forming apparatus 100.

A list illustrated in FIG. 4 is, for example, a list L1 of pieces of identification information of the user terminals 700 obtained by the image forming apparatus 100 via the terminal detection process performed at 8:00. In other words, the image forming apparatus 100 obtained the identification information from each of the user terminals 700 to which identification information of “PC1,” “PC2,” “PC3,” and “PC4” are respectively assigned, via the terminal detection process performed at 8:00.

A list illustrated in FIG. 5 is, for example, a list L2 of pieces of identification information of the user terminals 700 obtained by the image forming apparatus 100 via the terminal detection process performed at 9:00. In other words, the image forming apparatus 100 obtained the identification information from each of the user terminals 700 to which identification information of “PC1,” “PC3,” “PC4,” “PC5,” and “PC6” are respectively assigned, via the terminal detection process performed at 9:00.

The identification information may be any information as long as the user terminal 700 is uniquely identified. For example, the identification information may be an Internet protocol (IP) address, a media access control (MAC) address, or the like assigned to each user terminal 700.

The image forming apparatus 100 manages the obtained identification information by converting the obtained identification information into tabular data, or a data structure, (hereinafter, referred to as “detection result information”) in which, for example, a vertical axis is the identification information and a horizontal axis is a time at which the terminal detection process is performed. The detection result information managed by the image forming apparatus 100 is not limited to the tabular data described above, and may be data of any format as long as the time at which the terminal detection process is performed and the obtained identification information are matched.

In the present embodiment, it is assumed that the image forming apparatus 100 does not know an accurate number (total number) of the user terminals 700 connected to the communication network 800.

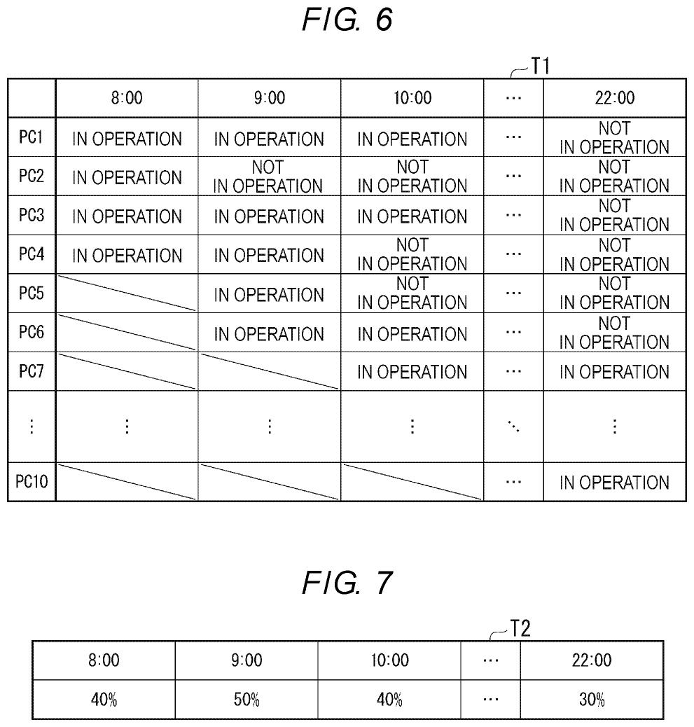

FIG. 6 is a diagram illustrating an example of the detection result information generated by the image forming apparatus 100. Detection result information T1 illustrated in FIG. 6 illustrates an example of detection result information generated when the image forming apparatus 100 performs the terminal detection process every hour from 8:00 to 22:00.

Referring again to FIG. 4, the number of pieces of identification information obtained by the image forming apparatus 100 via the terminal detection process performed at 8:00 is four, for example, “PC1,” “PC2,” “PC3,” and “PC4.” Accordingly, when the terminal detection process performed at 8:00 is completed, the number of records of the detection result information is four. Then, values corresponding to the four pieces of identification information are all set to “in operation.”

Referring again to FIG. 5, the number of pieces of identification information obtained by the image forming apparatus 100 via the terminal detection process performed at 9:00 is five, for example, “PC1,” “PC3,” “PC4,” “PC5,” and “PC6.” The image forming apparatus 100 may newly recognize the presence of two user terminals 700 to which new two pieces of identification information are respectively assigned, by obtaining the two pieces of identification information of “PC5” and “PC6” not obtained via the terminal detection process performed at 8:00. Accordingly, when the terminal detection process performed at 9:00 is completed, the number of records of the detection result information is increased by two to become six.

The image forming apparatus 100 may recognize that the identification information of “PC2” obtained via the terminal detection process performed at 8:00 is not obtained via the terminal detection process performed at 9:00. Accordingly, the image forming apparatus 100 may recognize that the user terminal 700 to which the identification information of “PC2” is assigned is changed from a state (in operation) usable by the image forming apparatus 100 to a state (not in operation) unusable by the image forming apparatus 100.

As such, the image forming apparatus 100 updates the detection result information whenever the terminal detection process is performed every hour from 8:00 to 22:00. Then, the detection result information at a time when a result of the terminal detection process performed at 22:00 is reflected becomes, for example, the detection result information T1 illustrated in FIG. 6.

The above process is an example of a process until the detection result information T1 is generated. Hereinafter, an example of an update process of firmware, which is performed based on the generated detection result information T1, will be described.

When the firmware of the image forming apparatus 100 needs to be updated, the administrator of the image forming apparatus 100 uses the administrator terminal 500 to perform an operation input for updating the firmware. Accordingly, instruction information (hereinafter, referred to as an “update instruction information”) indicating an instruction for updating the firmware is transmitted from the administrator terminal 500 to the image forming apparatus 100 through the communication network 800.

The image forming apparatus 100 obtains the update instruction information transmitted from the administrator terminal 500. Then, the image forming apparatus 100 selects a candidate of a time for updating the firmware by using the detection result information T1 generated as above. In particular, the candidate is selected as follows.

The image forming apparatus 100 selects, as the candidate, a time when an operation rate of the user terminals 700 is low, from 8:00 to 22:00 when the terminal detection process is performed. The image forming apparatus 100 calculates the operation rate by dividing the number of pieces of identification information of the user terminals 700 detected at each time the terminal detection process is performed by the number of all pieces of identification information of the user terminals 700 detected via the terminal detection processes from 8:00 to 22:00.

In the present embodiment, the image forming apparatus 100 selects a time when the operation rate of the user terminals 700 is low as the candidate, but an embodiment is not limited thereto. Any index may be used as long as the image forming apparatus 100 selects, as the candidate, a time when own availability of the image forming apparatus 100 is low. For example, the image forming apparatus 100 may select a time when the operating number of user terminals 700 is low as the candidate.

For example, as illustrated in FIG. 6, in the detection result information T1 to which results of all terminal detection processes from 8:00 to 22:00 are reflected, all pieces of detected identification information are “PC1” to “PC10,” for example, a total of ten. Accordingly, the image forming apparatus 100 estimates that the total number of user terminals 700 connected to the communication network 800 is ten.

On the other hand, for example, as illustrated in FIG. 6, the pieces of identification information detected via the terminal detection process at 8:00 are “PC1,” “PC2,” “PC3,” and “PC4, ” for example, a total of four. Accordingly, the image forming apparatus 100 calculates the operation rate at 8:00 as “40%” by dividing four by ten (the estimated total number). In the same manner, for example, as illustrated in FIG. 6, the pieces of identification information detected via the terminal detection process at 9:00 are “PC1,” “PC3,” “PC4,” “PC5,” and “PC6,” for example, a total of five. Accordingly, the image forming apparatus 100 calculates the operation rate at 9:00 as “50%” by dividing five by ten (the estimated total number).

As such, the image forming apparatus 100 calculates the operation rate of the user terminal 700 at each time from 8:00 to 22:00. The image forming apparatus 100 generates information (hereinafter, referred to as “operation rate information”) indicating a calculation result of the operation rate, based on the calculated operation rate. FIG. 7 is a diagram illustrating an example of operation rate information T2 generated by the image forming apparatus 100.

The image forming apparatus 100 selects a time when the operation rate of the user terminals 700 is low, based on the generated operation rate information. For example, the image forming apparatus 100 selects three operation rates in an order from the lowest value among the operation rates at each time indicated by the operation rate information, and specifies a time corresponding to each operation rate. For example, the image forming apparatus 100 selects three combination of time and operation rate of “22:00, 30%,” “8:00, 40%,” and “10:00, 40%.” The number of combinations to be selected is not limited to three, and can be any number.

The image forming apparatus 100 transmits information (hereinafter, referred to as “candidate time information” indicating the selected three combinations of time and operation rate to the administrator terminal 500 through the communication network 800.

The administrator terminal 500 obtains the candidate time information transmitted from the image forming apparatus 100. The administrator terminal 500 presents three candidate times based on the candidate time information to be selected by the administrator. For example, the administrator terminal 500 generates a screen (hereinafter, referred to as a “time selection screen”) enabling the administrator to select an update time, based on the obtained candidate time information. The administrator terminal 500 displays the generated time selection screen on, for example, a display unit (not illustrated) included in the administrator terminal 500. The display unit is configured of, for example, a display apparatus such as a liquid crystal display (LCD) or the like.

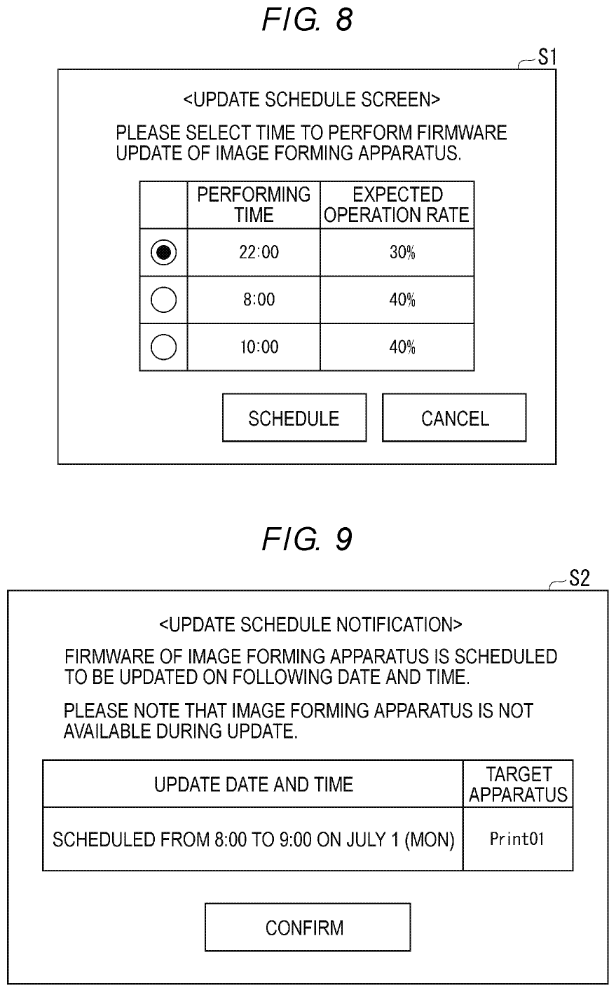

FIG. 8 is a diagram illustrating an example of a time selection screen displayed by the administrator terminal 500. As illustrated in FIG. 8, a time selection screen S1 displays three combinations of time and operation rate selected by the image forming apparatus 100. The three combinations of time and operation rate are displayed from the top in an order from, for example, the lowest operation rate. For example, a radio button is displayed on the left of each of regions where the three combinations of time and operation rate are displayed.

The administrator may select one of the three radio buttons and presses a “schedule” button displayed at the bottom of the time selection screen S1 to specify an update time of firmware. The administrator terminal 500 outputs information (hereinafter, referred to as “specified time information”) indicating the update time specified by the administrator to the image forming apparatus 100 through the communication network 800.

The image forming apparatus 100 obtains the specified time information output from the administrator terminal 500. The image forming apparatus 100 performs schedule setting of the own apparatus such that an update process of the firmware is started at the update time based on the obtained specified time information.

The image forming apparatus 100 broadcasts the specified time information to all user terminals 700 through the communication network 800. The image forming apparatus 100 broadcasts the specified time information to, for example, the ten user terminals 700 to which the pieces of identification information of “PC1” through “PC10” illustrated in FIG. 6 are respectively assigned.

Each user terminal 700 obtains the specified time information transmitted from the image forming apparatus 100. Each user terminal 700 presents, to the user, the update time based on the obtained specified time information. For example, the user terminal 700 generates a screen (hereinafter, referred to as an “alert screen”) for causing the user to recognize the update time of the firmware of the image forming apparatus 100, based on the obtained specified time information. The user terminal 700 displays the generated alert screen on, for example, a display unit (not illustrated) included in the own user terminal 700. The display unit is configured of, for example, a display apparatus such as an LCD or the like.

FIG. 9 is a diagram illustrating an example of the alert screen displayed by the user terminal 700. As illustrated in FIG. 9, information including the update time selected by the administrator terminal 500 is displayed on an alert screen S2. Accordingly, the user may determine a time during which the update process of the firmware of the image forming apparatus 100 is performed, by referring to the alert screen S2 displayed on the user terminal 700. By determining the time, the user recognizes a time during which the image forming apparatus 100 is not usable, and thus, for example, the user may pre-schedule work such that the user's work is not disturbed.

The image forming apparatus 100 stops a function (for example, an image forming function or the like) provided by the own image forming apparatus 100 when it is the update time specified by the administrator terminal 500. Then, the image forming apparatus 100 transmits information (hereinafter, referred to as “transmission request information”) for requesting transmission of new firmware to the distribution server 600 through the communication network 800.

Upon obtaining the transmission request information transmitted from the image forming apparatus 100, the distribution server 600 transmits new firmware to the image forming apparatus 100 through the communication network 800.

In the present embodiment, the image forming apparatus 100 obtains the new firmware by transmitting the transmission request information to the distribution server 600, but an embodiment is not limited to such a configuration. For example, the administrator terminal 500 may perform control such that the new firmware is transmitted from the distribution server 600 to the image forming apparatus 100 according to the selected update time.

The image forming apparatus 100 obtains the new firmware transmitted from the distribution server 600. Then, the image forming apparatus 100 replaces the firmware that was used in the own apparatus with the new firmware. Accordingly, the firmware of the image forming apparatus 100 is updated. When the update process of the firmware is completed, the image forming apparatus 100 resumes the function (for example, the image forming function or the like) provided by the own image forming apparatus 100.

Next, an operation example of the image forming apparatus 100 will be described.

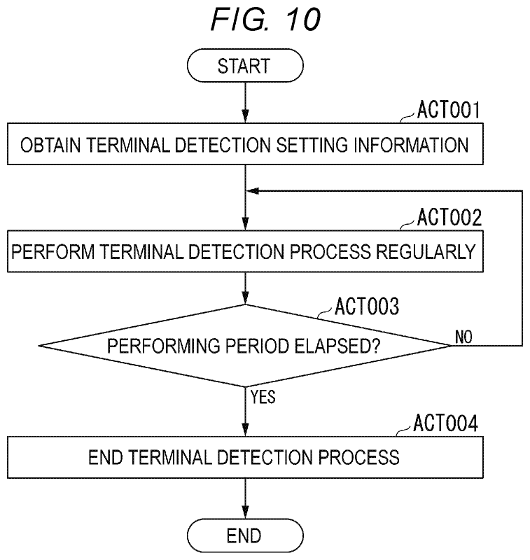

Hereinafter, an example of an operation of the image forming apparatus 100 when the terminal detection process is performed will be described. FIG. 10 is a flowchart of the terminal detection process by the image forming apparatus 100.

The communication unit 141 obtains the detection setting information transmitted from the administrator terminal 500 (ACT 001). The processor 180 performs the terminal detection process regularly (ACT 002) during a performing period and at performing intervals, based on the detection setting information obtained by the communication unit 141. The processor 180 updates the detection result information each time via the terminal detection process that is performed regularly.

When it is the performing period based on the detection setting information (ACT 003: No), the processor 180 continues to perform the terminal detection process (ACT 002). On the other hand, when the performing period based on the detection setting information is elapsed (ACT 003: Yes), the processor 180 ends the terminal detection process (ACT 004).

As above, the operation of the image forming apparatus 100 when the terminal detection process illustrated in the flowchart of FIG. 10 is performed is ended.

In the present embodiment, the processor 180 controls the start and end of performing the terminal detection process according to the performing period (that is, a performance start timing and a performance end timing) of the terminal detection process included in the detection setting information, but an embodiment is not limited to such a configuration. For example, the detection setting information may include only the performance start timing and the performing intervals of the terminal detection process, and the processor 180 may continue to perform the terminal detection process until a performance end instruction of the terminal detection process is obtained from the administrator terminal 500.

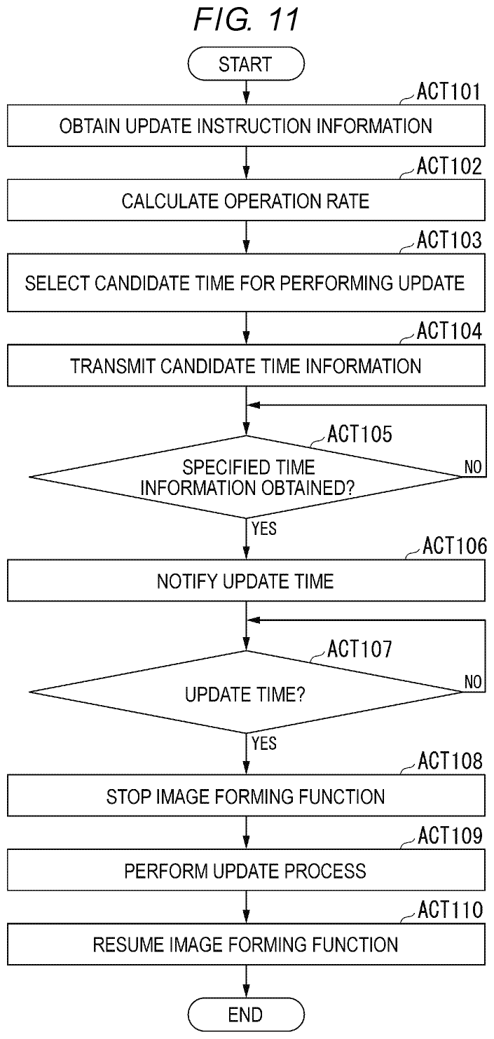

Hereinafter, an example of an operation of the image forming apparatus 100 when the update process of the firmware is performed will be described. FIG. 11 is a flowchart of the update process of the firmware by the image forming apparatus 100.

The communication unit 141 obtains the update instruction information transmitted from the administrator terminal 500 (ACT 101). The processor 180 calculates the operation rate of the user terminals 700 at each time when the terminal detection process is performed, by referring to the detection result information T1 stored in the storage unit 150 (ACT 102). The processor 180 generates the operation rate information T2 indicating the calculation result of the operation rate, and stores the operation rate information T2 in the storage unit 150.

The processor 180 selects a candidate time for updating the firmware, based on the generated operation rate information T2 (ACT 103). The image forming apparatus 100 transmits the candidate time information indicating the selected candidate time to the administrator terminal 500 (ACT 104).

The processor 180 obtains the specified time information indicating the time selected by the administrator among the selected candidate times transmitted from the administrator terminal 150. Upon obtaining the specified time information (ACT 105: Yes), the processor 180 broadcasts the specified time information to all user terminals 700. Accordingly, a scheduled time (update time) of performing the update process of the firmware is notified to all user terminals 700 (ACT 106).

When the processor 180 detects that it is the update time (ACT 107: Yes), the processor 180 stops the function (for example, the image forming function or the like) provided by the own image forming apparatus 100 (ACT 108). The communication unit 141 obtains the new firmware transmitted from the distribution server 600 and stores the obtained new firmware in the storage unit 150 under control of the processor 180. The processor 180 replaces the firmware that was used until then in the own apparatus with the new firmware stored in the storage unit 150. Accordingly, the update process of the firmware of the image forming apparatus 100 is performed (ACT 109).

When the update process of the firmware is completed, the image forming apparatus 100 resumes the function (for example, the image forming function or the like) provide by the own image forming apparatus 100 (ACT 110).

As above, the operation of the image forming apparatus 100 when the update process of the firmware illustrated in the flowchart of FIG. 11 is performed is ended.

As described above, the image forming apparatus 100 includes the communication unit 141 and the processor 180 (control unit). The communication unit 141 performs communication with the plurality of user terminals 700 connected to the communication network 800. The processor 180 (control unit) detects the user terminal 700 in operation based on the communication, analyzes an operation status of the user terminal 700 based on a result of the detection, and outputs a notification about availability of an apparatus based on the analyzed operation status.

With such a configuration, the image forming apparatus 100 may estimate a time during which the number of users of the own image forming apparatuses 100 is small, by analyzing the operation rate of the user terminal 700 for each time. The image forming apparatus 100 may present, to the administrator, the time during which the number of users of the own image forming apparatus 100 is small. Accordingly, the administrator may specify a timing of performing the update process of the firmware of the image forming apparatus 100 such that the update process is performed at the time during which the number of users of the image forming apparatus 100 is small. As a result, the image forming apparatus 100 may prevent a decrease of convenience with respect to the users.

In the above embodiment, the administrator performs the update process at the selected time, but an embodiment is not limited thereto. For example, the update process may be automatically performed at the time during which the calculated operation rate is the lowest. However, for safer and more accurate update process, the update process may preferably be performed at the time specified by the administrator as in the above embodiment.

The administrator may specify a predetermined period, for example, one day, one week, one month, or the like, and the image forming apparatus 100 may calculate the timing at which the operation rate is low during the predetermined period. For example, when the administrator specifies one month and a period, the timing at which the operation rate is low during one month is calculated. Here, a candidate timing of the update process is presented not only by a candidate time, but also by a time including a date. Accordingly, the image forming apparatus 100 may select an appropriate update timing (for example, a period of holidays or the like) from one month.

The image forming apparatus 100 may select a candidate timing of the update process in consideration of a process time (that is, the size of the update process) assumed to be required for the update process of the firmware. For example, when the time required for the update process is about 10 minutes, the image forming apparatus 100 may calculate the operation rate every 10 minutes and select a timing of about 10 to 20 minutes during which the calculated operation rate is low.

When the terminal detection process is continuously performed for a longer period, it is expected that estimation accuracy regarding the total number of user terminals connected to the communication network 800 is improved. When the terminal detection process is continuously performed for a longer period, it is expected that estimation accuracy regarding a time during which the operation rate is low is improved.

For example, the operation rate or the like may be further accurately estimated by performing machine learning or the like using information indicating an estimated operation rate of each time, which is accumulated in the past, and information indicating an actual operation rate of each time.

In the above embodiment, the storage unit 150 is provided in the image forming apparatus 100, but an embodiment is not limited thereto. The storage unit 150 may be provided, for example, in another device connected to the communication network 800. The terminal detection process and the update process of the firmware according to the above embodiment may be performed by a computer on a cloud.

A part of the image forming apparatus 100 according to the above embodiment may be realized by a computer. Here, a program for realizing a control function of the computer may be recorded on a computer readable recording medium, and a computer system may read and execute the program recorded on the recording medium.

Here, the “computer system” stated herein is a computer system embedded in the image forming apparatus 100 and includes software such as an operating system (OS) or the like and hardware such as a peripheral device or the like. The “computer readable recording medium” is a portable medium, such as a flexible disk, an optical magnetic disk, a flash memory, an electrically erasable programmable read only memory (EEPROM), a read only memory (ROM), a random access read/write memory (RAM), a compact disc-read only memory (CD-ROM), or the like, a storage device such as a hard disk or the like embedded in a computer system, or a recording medium configured by any combination thereof.

The “computer readable recording medium” may dynamically store a program for a short time like a communication line when transmitting a program through a communication network such as the Internet or the like or through a communication line such as a telephone line, or may store a program for a predetermined period of time like a volatile memory inside a computer system serving as a server or a client at that time. The program may be for realizing a part of the functions described above and may further be capable of realizing the functions described above in a combination with a program already recorded in the computer system.

Apart or all of the image forming apparatus 100 according to the embodiment described above may be realized as an integrated circuit such as a large scale integration (LSI) or the like. Each functional block of the image forming apparatus 100 may be individually made as a processor or a part of all may be integrated and made as a processor. A method of integrated circuit formation is not limited to LSI, and may be realized via a dedicated circuit or a general purpose processor. When an integrated circuit technology replacing LSI is introduced as a result of the advancement of semiconductor technology, an integrated circuit according to such a technology may be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image forming apparatus comprising:
a communication device configured to perform communications with a plurality of user terminals connected over a communication network; and
a controller configured to:
detect which of the user terminals is in operation based on the communications during a performing period of the user terminals with a performing interval;
analyze an operating status of the user terminals based on the detection;
output a notification about an availability of an image forming apparatus based on the analyzed operation status; and
update a program operating the image forming apparatus, responsive to the notification.

2. The apparatus according to claim 1, wherein
the controller is further configured to output timing information indicating at least one timing selected based on the analyzed operation status, the at least one timing corresponding to the availability of the image forming apparatus being low.

3. The apparatus according to claim 2, wherein
when the communication device obtains information indicating a response to the notification, the controller is further configured to update the program operating the image forming apparatus at a timing based on the information indicating the response.

4. The apparatus according to claim 2, wherein
the controller is further configured to specify a timing at which an operation rate of the user terminals is low, based on the analyzed operation status, and output a notification indicating the specified timing.

5. The apparatus according to claim 3, wherein
the controller is further configured to output, to the plurality of user terminals, information indicating a timing at which the program is updated.

6. The apparatus according to claim 1, wherein
the controller is further configured to obtain instruction information indicating an instruction related to a detection process of detecting the user terminals and perform the detection process, based on the instruction information.

7. The apparatus according to claim 6, wherein
the instruction information includes information indicating a performance start timing of the detection process and information indicating performance intervals of the detection process.

8. The apparatus according to claim 4, wherein
the controller is further configured to calculate the operation rate by dividing a number of the detected user terminals by a total number of the user terminals.

9. The apparatus according to claim 1, wherein
the controller is further configured to detect the user terminal using a simple network management protocol (SNMP).

10. A notification method comprising:
performing communications with a plurality of user terminals connected over a communication network;
detecting which of the user terminals is in operation based on the communications during a performing period of the user terminals with a performing interval;
analyzing an operation status of the user terminals based on a result of the detection;
outputting a notification about an availability of an image forming apparatus based on the analyzed operation status; and
updating a program operating the image forming apparatus, responsive to the notification.

11. The method of claim 10, further comprising:
outputting timing information indicating at least one timing selected based on the analyzed operation status, the at least one timing corresponding to the availability of the image forming apparatus being low.

12. The method of claim 11, further comprising:
updating the program operating the image forming apparatus at a timing based on a response to the notification.

13. The method of claim 10, further comprising:
obtaining instruction information indicating an instruction related to a detection process of detecting the user terminals; and
performing the detection process based on the instruction information.

14. The method of claim 13, wherein the instruction information includes information indicating a performance start timing of the detection process and information indicating performance intervals of the detection process.

15. The method of claim 10, further comprising:
detecting the user terminal using a simple network management protocol (SNMP).
